(19) United States
(12) Patent Application Publication
(10) Pub. No.: US 2023/0129409 A1
(43) Pub. Date: Apr. 27, 2023

(54) ALGORITHM FOR SECURE COMMUNICATIONS USING SYMMETRIC KEYS

(71) Applicant: Carrier Corporation, Palm Beach Gardens, FL (US)

(72) Inventor: Ravisankar Jakkula, Guntur District (IN)

(21) Appl. No.: 17/965,267

(22) Filed: Oct. 13, 2022

Related U.S. Application Data
(60) Provisional application No. 63/271,757, filed on Oct. 26, 2021.

(51) Int. Cl. H04L 9/40; H04L 9/32

(52) U.S. Cl. CPC H04L 63/0435; H04L 9/3242; H04L 63/123

(57) ABSTRACT

A method and system for establishing an encrypted communication between a server and client device. A method may include receiving an integrity check image in random-access memory (RAM) from a server; storing the integrity check image in the RAM of the device; and executing an integrity check using instructions of the integrity check image from the RAM. The method may include transmitting a hash value and a temporary cryptographic key to the server based on validating the integrity check image; receiving an encryption key from the server; and communicating with the server using the received encryption key.

### CROSS-REFERENCE TO RELATED APPLICATIONS

This application claims the benefit of Provisional Application No. 63/271,757 filed Oct. 26, 2021, the disclosure of which is incorporated herein by reference in its entirety.

### BACKGROUND

The present disclosure relates to establishing a secure communication, and more specifically, to using symmetric keys without identification and authentication processes to establish the secure communication.

In order to establish secure communication between a host and client, certificates and authentication processes are executed. The identification of the devices can be performed using certificates, and the authentication process can be performed using public and private keys. The certificates and public/private keys are vulnerable to being exposed during the exchange to establish the communication between the devices or during manufacturing. There may be a need to provide a technique to establish secure communications between a host and client without the exchange of digital certificates and public/private keys.

### BRIEF DESCRIPTION

According to an embodiment, a method for a client device to establish an encrypted communication is provided. The method can include receiving, at a client device, an integrity check image in random-access memory (RAM) from a server; storing the integrity check image in the RAM of the device; and executing an integrity check using instructions of the integrity check image from the RAM. The method can also include transmitting a hash value and a temporary cryptographic key to the server based on validating the integrity check image; receiving an encryption key from the server; and communicating with the server using the received encryption key.

In addition to one or more of the features described herein, or as an alternative, further embodiments include using an integrity check image that comprises a random key and instructions to validate an identifier of the client device and an application image of the client device.

In addition to one or more of the features described herein, or as an alternative, further embodiments include terminating the integrity check in the RAM of the client device and switching to application code, responsive to receiving and validating the encryption key, wherein the application code is stored in flash memory, wherein the encryption key is a symmetric encryption key.

In addition to one or more of the features described herein, or as an alternative, further embodiments include erasing the integrity check image from the RAM responsive to storing the encryption key on a flash memory of the client device.

In addition to one or more of the features described herein, or as an alternative, further embodiments include validating the encryption key prior to storing the encryption key in the flash memory of the client device.

In addition to one or more of the features described herein, or as an alternative, further embodiments include receiving a subsequent integrity check image for execution in the client device or terminating communication with the server responsive to the integrity check failing.

In addition to one or more of the features described herein, or as an alternative, further embodiments include erasing the flash memory and write the proper application image to the flash memory of the client device.

In addition to one or more of the features described herein, or as an alternative, further embodiments include periodically changing the encryption key.

According to an embodiment, a method for operating a server for establishing an encrypted communication is provided. The method includes transmitting, at the server, an integrity check image to a client device for storing on random-access memory (RAM) of the client device, wherein the integrity check image is executed in the RAM and controls operation of the client device; executing instructions of the integrity check image from the RAM; and receiving a hash value and a temporary cryptographic key from the client device, responsive to performing instructions of the integrity check image on the client device based on validating the integrity check image at the client device. The method can also include transmitting an encryption key to the client device; and communicating with the client device using the received encryption key.

In addition to one or more of the features described herein, or as an alternative, further embodiments include using an integrity check image that comprises a random key and instructions to validate an identifier of the client device and an application image of the client device.

In addition to one or more of the features described herein, or as an alternative, further embodiments include verifying the temporary cryptographic key and the application image prior to transmitting the encryption key to the client device, wherein the encryption key is a symmetric encryption key.

In addition to one or more of the features described herein, or as an alternative, further embodiments include terminating the integrity check in the RAM of the client device and switching to application code of the client device, responsive to receiving and validating the symmetric key, wherein the application code is stored in flash memory.

In addition to one or more of the features described herein, or as an alternative, further embodiments include validating the encryption key at the client device prior to storing the encryption on the flash memory of the client device.

In addition to one or more of the features described herein, or as an alternative, further embodiments include transmitting a subsequent integrity check image for execution in the client device or terminating communication with the client device responsive to the integrity check failing at the client device.

According to an embodiment, a system for establishing an encrypted communication between a server and a client device is provided. The system includes a server is configured to generate an integrity check image; and transmit the integrity check image to a client device. The client device is configured to receive and store the integrity check image in the random-access memory (RAM); execute instructions of the integrity check image from the RAM; transmit a hash value and a temporary cryptographic key to the server based on validating the integrity check image; receive an encryption key from the server; and communicate with the server using the received encryption key.

In addition to one or more of the features described herein, or as an alternative, further embodiments include using an integrity check image that comprises a random key and instructions to validate an identifier of the client device and an application image of the client device.

In addition to one or more of the features described herein, or as an alternative, further embodiments include using a symmetric encryption key.

In addition to one or more of the features described herein, or as an alternative, further embodiments include using a client device that is further configured to terminate the integrity check in the RAM of the client device and switch to application code responsive to receiving and validating the symmetric key, wherein the application code is stored in flash memory.

In addition to one or more of the features described herein, or as an alternative, further embodiments include using a client device that is further configured to erase the integrity check image from the RAM responsive to storing the encryption key on a flash memory of the client device.

In addition to one or more of the features described herein, or as an alternative, further embodiments include using a client device that is further configured to validate the encryption key prior to storing the encryption key in the flash memory of the client device.

Technical effects of embodiments of the present disclosure include implementing an algorithm that executes the identification and authentication of the client device or module without the use of digital certificates and public/private keys.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DES CRIPTION OF THE DRAWINGS

The following descriptions should not be considered limiting in any way. With reference to the accompanying drawings, like elements are numbered alike:

FIG. 1 depicts a system for establishing an encrypted communication between a server and a client device in accordance with one or more embodiments of the disclosure; and

FIG. 2 depicts a flowchart of a method for establishing an encrypted communication between a server and a client device in accordance with one or more embodiments of the disclosure.

### DETAILED DESCRIPTION

Communication vulnerabilities between a server and client may be exposed if the communication lines are tapped by an unauthorized user or if the firmware has been modified or comprised by a hacker. To establish the secure communication between devices, such as a server (host) and client, identification and authentication processes are executed prior to encrypting the communication. The authentication process ensures that the application, firmware, or program have not been compromised, and the identification process identifies the devices and/or modules that are authorized to connect to the server to perform the update.

Current encryption processes require the use of digital certificates and public/private key pairs to identify and authenticate the devices and firmware. These certificates may be stored in a database and must be transmitted over a network that may be vulnerable to being intercepted by unauthorized listening devices. In addition, many encryption algorithms are resource-intensive and require high processing power to perform the encryption/decryption processes. Therefore, the available resources of the devices must be considered when selecting the encryption algorithm.

The techniques described herein eliminate the vulnerability of exposing the certificates and/or keys prior to authenticating the devices to each other. No certificates or public/private keys are utilized. Also, the techniques described herein provide a method and system for establishing secure communication using symmetric keys without performing conventional device identification and authentication processes. The techniques described herein also provide a mechanism for providing encryption for low complexity devices with limited processing power and resources.

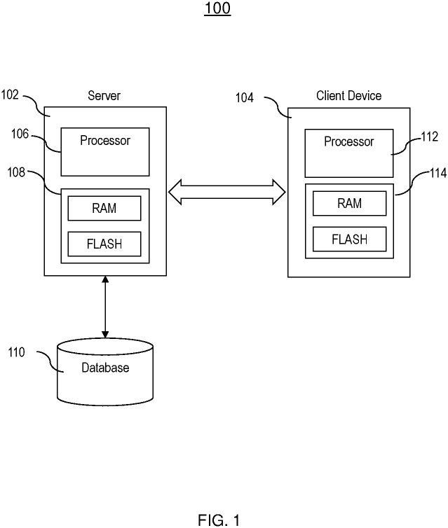

FIG. 1 depicts a system 100 for establishing an encrypted communication between a client and server in accordance with one or more embodiment of the disclosure. The system 100 includes a server 102 (host device) and a client device 104 (module). It should be understood that a plurality of client devices 104 can be coupled to the server 102 and is not limited by the example depicted in FIG. 1. In one or more embodiments of the disclosure, the server 102 or host device can be a fire panel. The server 102 includes a processor 106 and memory 108 to carry out the operations for establishing an encrypted communication between the server 102 and client device 104. It can be appreciated the server 102 can include other components or modules and is not limited by the components shown in FIG. 1. In one or more embodiments of the disclosure, the processor 106 can include a processor 106 of a general-purpose computer, special purpose computer, or other programmable data processing apparatus configured to execute instruction via the processor of the computer or other programmable data processing apparatus. The memory 108 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), etc.), internal flash, external NAND or NOR flash.

Referring to FIG. 1, the server 102 may be operably coupled to the database 110. In one or more embodiments of the disclosure, the database 110 can store configuration information for the client devices 104 that are coupled to the server 102. For example, the configuration information can include but is not limited to hardware identifiers such as medium access control (MAC) addresses, firmware versions, applications, client device firmware package, etc.

The client device 104 also includes a processor 112 and memory 114. The processor 112 and memory 114 may be similar to the processor 106 and memory 108 of the server 102. It can be appreciated the client device 104 can include other components or modules and is not limited by the components shown in FIG. 1. In one or more embodiments of the disclosure, the client devices 104 and/or modules can include but are not limited to local rail modules, loop controllers, input modules, output modules, audio modules.

In one or more embodiments of the disclosure, the server 102 and client device 104 can communicate over a network. The network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof. The network(s) can also include controller area network (CAN) such as but not limited to other communications including I2C, UART, etc.

In one or more embodiments of the disclosure, the RAM memory of the client device 104 is configured with an integrity check image for operating the client device 104. The flash application that running in client device 104 is suspended and start the RAM integrity check application. This integrity check includes a temporary cryptographic key that is embedded in the integrity check image. This allows for the client device 104 identification and application/firmware authentication prior to get the symmetric key from server 102 with temporary cryptographic key, and it will install the symmetric key in the flash memory of the client device 104. After a successful identification process and authentication process the operation of the client device 104 resumes the application operation that was previously suspended to perform the integrity check from the server 102 with new symmetric key. In addition, the server 102 and client device 104 commences the communication using the cryptographic key.

In one or more embodiments of the disclosure, the flash memory of the client device 104 is configured with an application image for operating the client device 104. The application is suspended to perform an integrity check that is stored in the RAM of the client device 104. This allows for the client device 104 identification and application/firmware authentication prior to be installed in the flash memory of the client device 104. After a successful identification process and authentication process, the operation of the client device 104 may resume the execution of the application that was previously suspended to perform the integrity check from the server 102. In addition, the server 102 and client device 104 commences the communication using the cryptographic key.

One or more illustrative embodiments of the disclosure are described herein. Such embodiments are merely illustrative of the scope of this disclosure and are not intended to be limiting in any way. Accordingly, variations, modifications, and equivalents of embodiments disclosed herein are also within the scope of this disclosure.

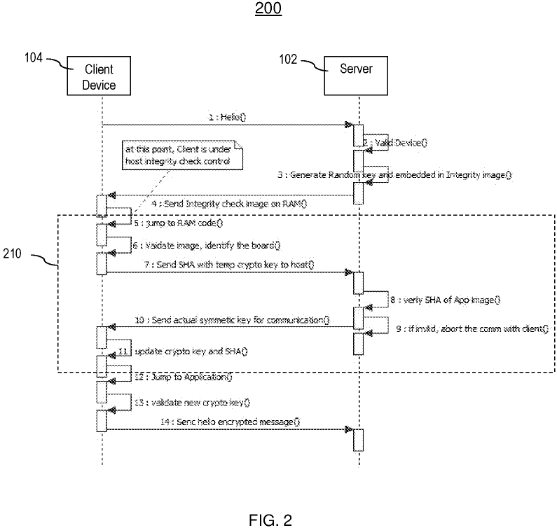

FIG. 2 depicts an example process flow of a method 200 for establishing the encrypted communication in accordance with one or more embodiments of the disclosure. The method 200 can be incorporated in a system 100 such as that shown in FIG. 1. The method 200 begins at step 1 and the client device 104 provides a hello message to the server 102. The hello message can indicate to the server 102 the client device 104 is connecting to the server 102.

In one or more embodiments of the disclosure, the client device 104 has been detected on the bus of the server 102, the server 102 will obtain the configuration details of the client device 104. The server 102 is configured to store various information for each of the client devices 104 in the database 110. For example, the stored information can include the client device model, client device identifiers, firmware versions, etc. Other examples for the stored information can include configuration details of the client device 104 such as but not limited to the device personality, input/output types, analog threshold values, etc. After the server 102 receives the hello message, as shown in step 2, the server 102 can validate the client device 104. The server 102 can compare an identifier of the client device 104 included in the hello message with an identifier stored in the server 102. If the server 102 determines the client device 104 is valid, at step 3 the server 102 can generate a random key and embed it in an integrity check image.

At step 4, the server 102 transmits the integrity check image to the client device 104. In one or more embodiments of the disclosure, the integrity check image is stored in the RAM of the client device 104. The integrity check is not stored in the flash storage of the client device but remains in RAM. The integrity check is performed to identify the client device 104 to the server 102 and obviates the need to use any digital certificates to identify the client device 104. The integrity check is performed under the control of the server 102 prior to exchanging any encryption keys for use in communication which may become exposed to an unauthorized listener or hacker.

In one or more embodiments of the disclosure, the integrity check image can provide instructions to obtain hardware and/or device identifier information such as but not limited to the MAC ID and/or MCU ID. In addition, the integrity check image can provide instructions to read the application image from the flash memory of the client device 104. In one or more embodiments of the disclosure, a cyclic redundancy check (CRC), a checksum, a key, a hash or some other key is calculated for the application image of the client device 104.

At step 5 of the method 200, the client device 104 suspends the application code that is current running and jumps to the RAM code to execute the integrity check. At this point, the client device 104 is under control of server 102 integrity check control. At step 6, the client device 104, as part of the integrity check image, validates the application image of the client device 104 and identifies the client device 104. The values of the integrity check image can be compared to the calculated values for the application image. In one or more embodiments, the server 102 already has knowledge of the client device 104 information and the application image information of the client device 104 so it can readily identify whether the application image has been modified or if the correct client device 104 has been identified.

If the integrity check is validated, meaning the proper values for the integrity check are determined, the client device 104 can provide a hash, such as secure hash algorithm (SHA), with a temporary crypto key to the server 102 as shown in step 7.

In the event the integrity check is not validated, a message can be provided to the server 102 to indicate the failure of the integrity check. In another embodiment, an expiration of a time period can indicate a failure at the server 102. In such a case where there is a timeout or expiration of a time period, a subsequent integrity check image can be generated at the server 102 and transmitted to the client device 104 for storing and execution in the RAM. In one or more embodiments of the disclosure, if the integrity check has fails, the server 102 can erase the application image stored in the flash memory of the client device 104, and the appropriate application image can be sent from the server 102 to the client device 104. The client device 104 can store the application image in the flash memory with a temporary cryptograph key which is part of the integrity image. Subsequently, after performing the SHA of the application image, the temporary cryptographic key can be sent to the server 102.

At step 8, the server 102 verifies the hash with the received hash. If a match is determined between the received hash and the calculated hash for the application image, only then, will the server 102 transmit the symmetric key to be used for the encrypted communication. The server 102 receives the hash with the temporary crypto key and performs a verification process. During the verification process, the server 102 executes the hash for the application image for the client device 104.

In the event the hash of the application image is not verified, at step 9, the communication process may be invalidated and aborted. This can indicate the firmware may have been modified by a hacker. In one or more embodiments of the disclosure, any further communication from the client device 104 can be terminated to reduce any potential exposure to any unwanted manipulation.

If the hash of the application image is verified, the server 102 sends the encryption key for communication to the client device 104. Responsive to receiving the encryption key, the client device 104 updates the encryption key and the SHA in step 11. During the update the encryption key and SHA are stored in the flash memory. At this time, the integrity check is completed in RAM and at step 12 the process returns to the application code stored in the flash to operate the device/module. At step 13, the symmetric key is then validated at the client device 104 while running the application code and then uses for encrypted communication as shown in step 14. Symmetric keys are used for communication and symmetric key algorithms use the same cryptographic keys for encryption of plaintext and decryption of ciphertext. The keys may be symmetrical or there may be a transformation between the keys. In one or more embodiments of the disclosure, after the successful cryptographic communication beings, the server 102 can periodically inform the client device 104 to change or update the symmetric key, and the server 102 can send the new encrypted symmetric key to the client device 104. By updating the encrypted symmetric key, the server 102 and client device 104 can avoid any run-time brute force attack. The period for updating or switching the symmetric keys can be random or the period can be 5, 10, 15 seconds, etc.

The steps shown in FIG. 2 are not intended to limit the scope of the disclosure but it can be appreciated that different steps or a different sequence of steps can be included to perform the operations to establish secure communication without the use of digital certificates and private/public keys.

The technical effects and benefits include obtaining the trust of a device based on the integrity of the device. The technical effects and benefits also include eliminating the need for exchanging digital certificates to identify a device and eliminating the need for public/private keys for encryption. The technical effects and benefits can include reducing cyber processes in the manufacturing, and the man-in-the-middle attacks can be avoided using the techniques described herein. The techniques described herein can be deployed in low profile microcontroller unit (MCU) using the simple encryption algorithm.

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method for a client device to establish an encrypted communication, the method comprising:
receiving, at a client device, an integrity check image in random-access memory (RAM) from a server;
storing the integrity check image in the RAM of the device;
executing an integrity check using instructions of the integrity check image from the RAM;
transmitting a hash value and a temporary cryptographic key to the server based on validating the integrity check image;
receiving an encryption key from the server; and
communicating with the server using the received encryption key.

2. The method of claim 1, wherein the integrity check image comprises a random key and instructions to validate an identifier of the client device and an application image of the client device.

3. The method of claim 1, further comprising terminating the integrity check in the RAM of the client device and switching to application code, responsive to receiving and validating the encryption key, wherein the application code is stored in flash memory, wherein the encryption key is a symmetric encryption key.

4. The method of claim 1, further comprising erasing the integrity check image from the RAM responsive to storing the encryption key on a flash memory of the client device.

5. The method of claim 1, further comprising validating the encryption key prior to storing the encryption key in the flash memory of the client device.

6. The method of claim 1, further comprising receiving a subsequent integrity check image for execution in the client device or terminating communication with the server responsive to the integrity check failing.

7. The method of claim 1, further comprising erasing the flash memory and write the proper application image to the flash memory of the client device.

8. The method of claim 1, further comprising periodically changing the encryption key.

9. A method for operating a server for establishing an encrypted communication, the method comprising:
transmitting, at the server, an integrity check image to a client device for storing on random-access memory (RAM) of the client device, wherein the integrity check image is executed in the RAM and controls operation of the client device;
executing instructions of the integrity check image from the RAM;
receiving a hash value and a temporary cryptographic key from the client device, responsive to performing instructions of the integrity check image on the client device based on validating the integrity check image at the client device;
transmitting an encryption key to the client device; and
communicating with the client device using the received encryption key.

10. The method of claim 9, wherein the integrity check image comprises a random key and instructions to validate an identifier of the client device and an application image of the client device.

11. The method of claim 9, further comprising verifying the temporary cryptographic key and the application image prior to transmitting the encryption key to the client device, wherein the encryption key is a symmetric encryption key.

12. The method of claim 9, further comprising terminating the integrity check in the RAM of the client device and switching to application code of the client device, responsive to receiving and validating the symmetric key, wherein the application code is stored in flash memory.

13. The method of claim 9, further comprising validating the encryption key at the client device prior to storing the encryption on the flash memory of the client device.

14. The method of claim 9, further comprising transmitting a subsequent integrity check image for execution in the client device or terminating communication with the client device responsive to the integrity check failing at the client device.

15. A system for establishing an encrypted communication between a server and client device, the method comprising:
a server configured to:
generate an integrity check image;
transmit the integrity check image to a client device;
the client device configured to:
receive and store the integrity check image in the random-access memory (RAM);
execute instructions of the integrity check image from the RAM;
transmit a hash value and a temporary cryptographic key to the server based on validating the integrity check image;
receive an encryption key from the server; and
communicate with the server using the received encryption key.

16. The system of claim 15, wherein the integrity check image comprises a random key and instructions to validate an identifier of the client device and an application image of the client device.

17. The system of claim 15, wherein the encryption key is a symmetric encryption key.

18. The system of claim 15, wherein the client device is further configured to terminate the integrity check in the RAM of the client device and switch to application code responsive to receiving and validating the symmetric key, wherein the application code is stored in flash memory.

19. The system of claim 15, wherein the client device is further configured to erase the integrity check image from the RAM responsive to storing the encryption key on a flash memory of the client device.

20. The system of claim 15, wherein the client device is further configured to validate the encryption key prior to storing the encryption key in the flash memory of the client device.
